(19) United States
(12) Patent Application Publication
(10) Pub. No.: US 2025/0382073 A1
(43) Pub. Date: Dec. 18, 2025

(54) INTEGRATED PROPULSION AND POWER GENERATION SYSTEM FOR SPACECRAFT AND CONTROL METHOD THEREOF

(71) Applicant: SHANGHAI INSTITUTE OF SPACE PROPULSION, Shanghai (CN)

(72) Inventors: Tao SUN, Shanghai (CN); Yuanding WANG, Shanghai (CN); Manli GUO, Shanghai (CN); Yingyuan WANG, Shanghai (CN); Yu ZHANG, Shanghai (CN); Weikun LI, Shanghai (CN); Chengbo SHI, Shanghai (CN)

(21) Appl. No.: 18/999,097

(22) Filed: Dec. 23, 2024

(30) Foreign Application Priority Data
Jun. 17, 2024 (CN) 202410778352.3

(51) Int. Cl. B64G 1/40; F02K 9/58

(52) U.S. Cl. CPC B64G 1/402; F02K 9/58

(57) ABSTRACT

Provided are an integrated propulsion and power generation system for a spacecraft and a control method thereof. The integrated propulsion and power generation system includes a propellant supply module, an engine branch, a power generation branch, and a controller, where the propellant supply module includes a first reversing valve and a second reversing valve; and the controller is configured to: control the first reversing valve and the second reversing valve to switch states, and control the propellant supply module to be controlled to one or two of the engine branch and the power generation branch.

### CROSS REFERENCE TO RELATED APPLICATION

This patent application claims the benefit and priority of Chinese Patent Application No. 202410778352.3, filed with the China National Intellectual Property Administration on Jun. 17, 2024, the disclosure of which is incorporated by reference herein in its entirety as part of the present application.

### TECHNICAL FIELD

The present disclosure relates to the technical field of spacecrafts, and in particular, relates to an integrated propulsion and power generation system for a spacecraft and a control method thereof.

### BACKGROUND

An existing spacecraft is mainly powered by a solar panel. In a high-power scenario, sufficient power cannot be obtained, and an additional power generation system needs to be additionally disposed. In addition, a power module of the propulsion system of the spacecraft generally cannot be adjusted, or a complex adjustment mechanism is required to adjust thrust. The additional power generation system and the existing adjustment mechanism for the power module are disposed, increasing design costs, bringing significant challenges to directional precision, disturbance control, and the like of the spacecraft, and making it difficult to implement in engineering.

In view of this, designing an integrated propulsion and power generation system for a spacecraft that can achieve integration of propulsion and power generation of the spacecraft, and improve control precision is a technical problem that needs to be resolved by a person skilled in the art.

### SUMMARY

To resolve the technical problem, the present disclosure provides an integrated propulsion and power generation system for a spacecraft and a control method thereof, to achieve integration of propulsion and power generation of the spacecraft, and improve control precision.

According to a first aspect, the present disclosure provides an integrated propulsion and power generation system for a spacecraft, including a propellant supply module, an engine branch, a power generation branch, and a controller, where
the propellant supply module includes a first reversing valve and a second reversing valve; and
the controller is configured to: control the first reversing valve and the second reversing valve to switch states, and control the propellant supply module to be connected to one or two of the engine branch and the power generation branch.

Optionally, the propellant supply module further includes a first high-pressure gas cylinder, a fuel storage tank, a second high-pressure gas cylinder, an oxidant storage tank, a first liquid path self-locking valve, and a second liquid path self-locking valve, where
an input end of the first liquid path self-locking valve is connected to an output end of the fuel storage tank, and an output end of the first liquid path self-locking valve is connected to a first input end of the first reversing valve; and
an input end of the second liquid path self-locking valve is connected to an output end of the oxidant storage tank, and an output end of the second liquid path self-locking valve is connected to an input end of the second reversing valve.

Optionally, outlet flow of the fuel storage tank meets the following formula:

$${Q}_{storage tank} = {Q}_{t} + {Q}_{1} , \qquad ( 1 )$$

where
Q_{storage tank} is the outlet flow of the fuel storage tank, Qₜ is fuel flow of the engine branch, and Q₁ is fuel flow of the power generation branch.

Optionally, the engine branch includes a main engine, where a first output end of the first reversing valve is connected to a first input end of the main engine, and a first output end of the second reversing valve is connected to a second input end of the main engine.

Optionally, the power generation branch includes a first flow control valve, a second flow control valve, a gas generator, a turbine, a power generator, and a battery pack, where
a second output end of the first reversing valve is connected to the first flow control valve, a second transmission end of the second reversing valve is connected to an input end of the second flow control valve; and an output end of the first flow control valve and an output end of the second flow control valve are separately connected to the gas generator, and an output end of the gas generator is connected to a gas inlet end of the turbine.

Optionally, the first reversing valve and the second reversing valve are three-position four-way valves; and the controller is configured to control the first reversing valve and the second reversing valve to switch among a working mode I, a working mode II, and a working mode III.

Optionally, the system further comprises a tail gas treatment unit, and the tail gas treatment unit includes a throttling component and a tail gas treatment device.

Optionally, the throttling component includes a first throttling element and a second throttling element, and is configured to throttle gas output by the turbine.

Optionally, the tail gas treatment device includes an exhaust pipe, and each of a first end and a second end of the exhaust pipe is provided with a plurality of exhaust vents.

Optionally, a middle part of the exhaust pipe is further provided with a first inlet pipe, and a second inlet pipe; and an output end of the first throttling element is connected to an inlet end of the first inlet pipe, and an output end of the second throttling element is connected to an inlet end of the second inlet pipe; and
a joint between the first inlet pipe and the exhaust pipe and a joint between the second inlet pipe and the exhaust pipe are further provided with a third throttling element and a fourth throttling element.

According to a second aspect, the present disclosure further provides a control method of an integrated propulsion and power generation system for a spacecraft, where the method is applied to the foregoing integrated propulsion and power generation system for a spacecraft. The method includes the following steps:
calculating a real-time opening degree value of a first flow control valve and a real-time opening degree value of a second flow control valve according to a preset condition; and
controlling, by a controller, an opening degree of the first flow control valve according to the real-time opening degree value of the first flow control valve, and an opening degree of the second flow control valve according to the real-time opening degree value of the second flow control valve.

Compared with the prior art, the present disclosure has the following beneficial effects:

According to the present disclosure, a propulsion function and a power generation function are integrated through the engine branch and the power generation branch that are connected in parallel. The first reversing valve and the second reversing valve are switched in a plurality of modes to convert chemical energy of excessive fuel carried in the spacecraft into electric energy. In addition, a working requirement of a propulsion system and a requirement for the power generation function of the spacecraft are met, and requirements in different use scenarios are met. The tail gas treatment module is further disposed, and disturbing force on the spacecraft in a tail gas exhaust process is eliminated by cancelling out counterforce of the throttling component and gas flowing through the exhaust vents of the exhaust pipe on the structures. In addition, flow distribution is adjusted by the control method to adjust thrust and generated power of the propulsion and power generation system, achieving integrated control on the propulsion function and the power generation function of the spacecraft.

### BRIEF DESCRIPTION OF THE DRAWINGS

Other features, objectives, and advantages of the present disclosure will become more apparent by reading the detailed description of non-limiting embodiments with reference to the following accompanying drawings.

FIG. 1 is a schematic diagram of a conventional propulsion system for a spacecraft in the prior art;

FIG. 2 is a schematic diagram of an integrated propulsion and power generation system for a spacecraft according to the present disclosure;

FIG. 3 is a schematic diagram of a tail gas treatment device according to the present disclosure; and

FIG. 4 is a sectional view of a tail gas treatment device according to the present disclosure.

Reference numerals:

1: main engine;
2: fuel storage tank;
3: oxidant storage tank;
4: first high-pressure gas cylinder;
5: second high-pressure gas cylinder;
6: flow meter;
7: pressure meter;
11: first filter;
12: gas path self-locking valve;
13: first pressure reducing valve;
14: first liquid path self-locking valve;
15: first reversing valve;
21: second filter;
22: second gas path self-locking valve;
23: second pressure reducing valve;
24: second liquid path self-locking valve;
25: second reversing valve;
31: first flow control valve;
32: second flow control valve;
33: gas generator;
34: turbine;
35: power generator;
36: battery pack;
41: first throttling element;
42: second throttling element;
43: tail gas treatment device;
431: exhaust pipe;
432: first inlet pipe;
433: second inlet pipe;
4311: exhaust vent;
4312: third throttling element; and
4313: fourth throttling element.

### DETAILED DESCRIPTION OF THE EMBODIMENTS

The present disclosure is described in detail below with reference to specific embodiments. The following embodiments will help those skilled in the art to further understand the present disclosure, but do not limit the present disclosure in any way. It should be noted that several variations and improvements can also be made by a person of ordinary skill in the art without departing from the conception of the present disclosure. These all fall within the protection scope of the present disclosure.

### Embodiment 1

The present disclosure discloses an integrated propulsion and power generation system for a spacecraft, including a propellant supply module, an engine branch, a power generation branch, and a controller, where the propellant supply module includes a first reversing valve and a second reversing valve; and the controller is configured to: control the first reversing valve and the second reversing valve to switch states, and control the propellant supply module to be controlled to one or two of the engine branch and the power generation branch. According to the integrated propulsion and power generation system for a spacecraft, a propulsion function and a power generation function are integrated through the engine branch and the power generation branch that are connected in parallel. The first reversing valve and the second reversing valve are switched in a plurality of modes to convert chemical energy of excessive fuel carried in the spacecraft into electric energy. In addition, a working requirement of a propulsion system and a requirement for the power generation function of the spacecraft are met, and requirements in different use scenarios are met.

To resolve the technical problem, the present disclosure provides an integrated propulsion and power generation system for a spacecraft and a control method thereof, to achieve integration of space propulsion and power generation, and improve control precision.

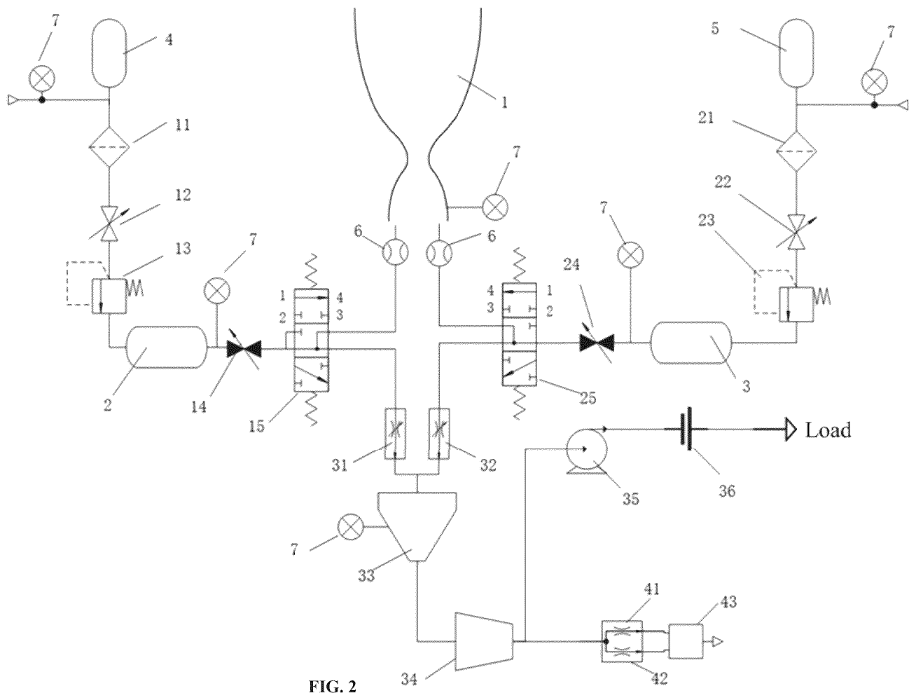

Refer to FIG. 2. According to a first aspect, the present disclosure provides an integrated propulsion and power generation system for a spacecraft, including a propellant supply module, an engine branch, a power generation branch, and a controller.

The propellant supply module includes a first reversing valve and a second reversing valve.

The controller is configured to: control the first reversing valve and the second reversing valve to switch states, and control the propellant supply module to be connected to one or two of the engine branch and the power generation branch.

Preferably, the propellant supply module further includes a first high-pressure gas cylinder, a fuel storage tank, a second high-pressure gas cylinder, an oxidant storage tank, a first liquid path self-locking valve, and a second liquid path self-locking valve.

An input end of the first liquid path self-locking valve is connected to an output end of the fuel storage tank, and an output end of the first liquid path self-locking valve is connected to a first input end of the first reversing valve.

An input end of the second liquid path self-locking valve is connected to an output end of the oxidant storage tank, and an output end of the second liquid path self-locking valve is connected to an input end of the second reversing valve.

Preferably, outlet flow of the fuel storage tank meets the following formula:

$${Q}_{storage tank} = {Q}_{t} + {Q}_{1} , \qquad ( 1 )$$

where
Q_{storage tank} is the outlet flow of the fuel storage tank, Qₜ is fuel flow of the engine branch, and Q₁ is fuel flow of the power generation branch.

Preferably, the engine branch includes a main engine, where a first output end of the first reversing valve is connected to a first input end of the main engine, and a first output end of the second reversing valve is connected to a second input end of the main engine.

Preferably, the power generation branch includes a first flow control valve, a second flow control valve, a gas generator, a turbine, a power generator, and a battery pack.

A second output end of the first reversing valve is connected to the first flow control valve, a second transmission end of the second reversing valve is connected to an input end of the second flow control valve; and an output end of the first flow control valve and an output end of the second flow control valve are separately connected to the gas generator, and an output end of the gas generator is connected to a gas inlet end of the turbine.

Preferably, an opening of the first flow control valve is controlled via a percentage logarithm, and a calculation formula is as follows:

$$ln \frac{{Q}_{1}}{{Q}_{max}} = k \frac{1}{L} + C \qquad ( 2 )$$

Boundary conditions are as follows:
when Q=Qₘᵢₙ, l=0;
when Q=Qₘₐₓ, l=L;

$$R = \frac{{Q}_{min}}{{Q}_{max}}$$

the boundary conditions are substituted into the formula (2) to deduce the following formula:

$$\frac{{Q}_{1}}{{Q}_{max}} = \frac{{e}^{( \frac{1}{L} lnR )}}{R} , \qquad ( 3 )$$

where
Qₘᵢₙ and Qₘₐₓ are minimum flow and maximum flow of the flow control valve, R is a ratio of the minimum flow to the maximum flow, l is an opening degree of the first flow control valve, and L is a maximum opening degree of the first flow control valve; and for a selected flow control valve, Qₘᵢₙ, Qₘₐₓ, and L are known values.

Target fuel flow of the engine branch is set as Qₛ, actual flow of the engine branch is set as Qₜ, and a formula for calculating a real-time opening degree of the first flow control valve is as follows:

$${l}_{t + 1} = {l}_{t} + Δ l \qquad ( 4 )$$

$$Δ l = - \frac{{Q}_{t} - {Q}_{s}}{λ} - \frac{( {Q}_{t} + {Q}_{t - Δ t} + {Q}_{t - 2 Δ t} - {Q}_{t - 3 Δ t} - {Q}_{t - 4 Δ t} - {Q}_{t - 5 Δ t} )}{5 Δ t} * μ * κ ,$$

where
lₜ₊₁ is an opening control degree of the first flow control valve at a next moment, lₜ is an opening degree of the first flow control valve at a current moment, Δl is an opening degree control increment, Qₜ is flow of the engine branch at the current moment, Qₛ is the target flow of the engine branch, λ is a proportion coefficient, Δt is a sampling interval of the system, Qₜ to Q_{t-5Δt} respectively correspond to flow, that is sampled for six consecutive times, of the engine branch, and μ is a compensation coefficient; and Qₜ−Qₛ represents a difference between the flow at the current moment and the target flow, and

$$\frac{( {Q}_{t} + {Q}_{t - Δ t} + {Q}_{t - 2 Δ t} - {Q}_{t - 3 Δ t} - {Q}_{t - 4 Δ t} - {Q}_{t - 5 Δ t} )}{5 Δ t}$$

represents a change value of Qₜ.

κ is a correction coefficient, where when t>6Δt, κ=1; and when t≤6Δt, κ=0.

In the formula, sampling time, and a sampling moment obtained through averaging are set according to an actual requirement.

The controller is configured to control the opening degree of the first flow control valve according to the obtained controlled real-time opening value of the first flow control valve.

Preferably, the first reversing valve and the second reversing valve are three-position four-way valves; and the controller is configured to control the first reversing valve and the second reversing valve to switch among a working mode I, a working mode II, and a working mode III.

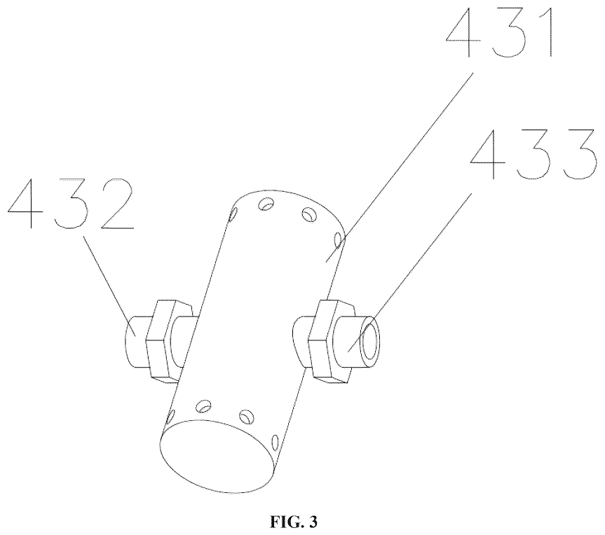

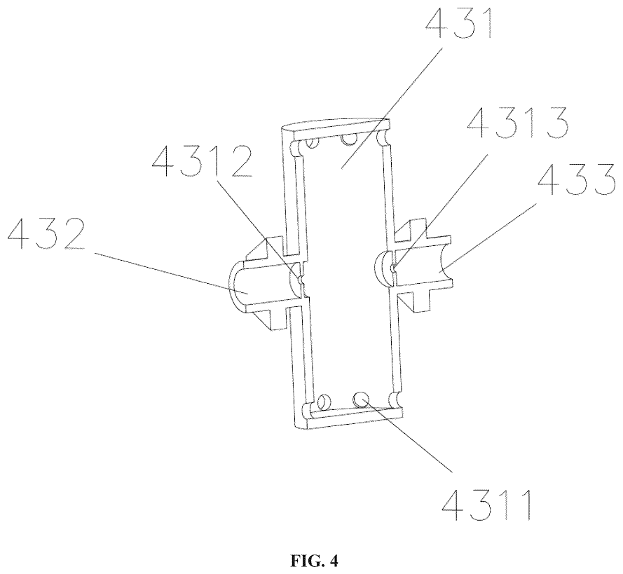

Refer to FIG. 3 and FIG. 4. Optionally, the system further includes a tail gas treatment unit, and the tail gas treatment unit includes a throttling component and a tail gas treatment device.

Preferably, the throttling component includes a first throttling element and a second throttling element, and is configured to throttle gas output by the turbine.

Preferably, the tail gas treatment device includes an exhaust pipe, and each of a first end and a second end of the exhaust pipe is provided with a plurality of exhaust vents.

Preferably, the middle part of the exhaust pipe is further provided with a first inlet pipe, and a second inlet pipe; and an output end of the first throttling element is connected to an inlet end of the first inlet pipe, and an output end of the second throttling element is connected to an inlet end of the second inlet pipe.

Preferably, a joint between the first inlet pipe and the exhaust pipe and a joint between the second inlet pipe and the exhaust pipe are further provided with a third throttling element and a fourth throttling element.

According to a second aspect, the present disclosure further provides a control method applied to an integrated propulsion and power generation system for a spacecraft. The method includes the following steps.

A real-time opening degree value of a first flow control valve and a real-time opening degree value of a second flow control valve are calculated according to a preset condition.

An opening degree of the first flow control valve is controlled by a controller according to the real-time opening degree value of the first flow control valve, and an opening degree of the second flow control valve is controlled by the controller according to the real-time opening degree value of the second flow control valve.

### Embodiment 2

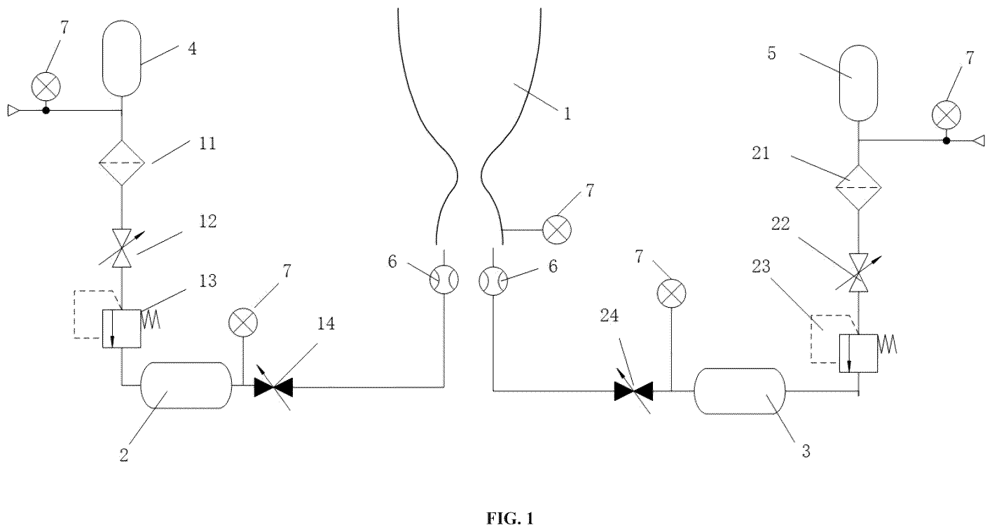

FIG. 1 is a schematic diagram of a conventional propulsion system for a spacecraft in the prior art. The propulsion system is configured to supply power through a solar panel, and includes a first high-pressure gas cylinder 4, a second high-pressure gas cylinder 5, a fuel storage tank 2, an oxidant storage tank 3, and a main engine 1. The first high-pressure gas cylinder 4 and the second high-pressure gas cylinder 5 are separately connected to the fuel storage tank 2 and the oxidant storage tank 3 through a pipeline I and a pipeline II.

Gas in the high-pressure gas cylinder is helium gas or nitrogen gas. There is kerosene, alcohol, unsymmetrical dimethylhydrazine or liquid hydrogen in the fuel storage tank. There is liquid oxygen or dinitrogen tetroxide in the oxidant storage tank.

The pipeline I is sequentially provided with a first filter 11, a gas path self-locking valve 12 and a second pressure reducing valve 13. The pipeline II is sequentially provided with a second filter 21, a liquid path self-locking valve 22, and a second pressure reducing valve 23.

A first liquid path self-locking valve 14 and a second liquid path self-locking valve 24 are respectively disposed between the fuel storage tank 2 and the main engine 1, and between the oxidant storage tank 3 and the main engine 1.

Although the propulsion system for a spacecraft is further provided with a plurality of flow meters 6 and pressure meters 7 that are configured to detect pressure and flow of the system, during actual control, coordinated control and feedback control are not performed on flow in the two pipelines in consideration of costs and disturbance. Therefore, control precision of the propulsion system is not high.

In view of this, the present disclosure provides an integrated propulsion and power generation system for a spacecraft, to convert chemical energy in excessive fuel carried in the spacecraft into electric energy and adjust output thrust of a power module of the propulsion system in a case of not carrying a complex load. In other words, integration of a power generation system of the spacecraft and an adjustment system of the power module in a same system is an efficient selection. Based on this, an adaptive control method is designed to control a flow distribution relationship between a power system and the power generation system in a coordinated manner, improving propulsion precision and efficiency of the spacecraft.

Refer to FIG. 2. FIG. 2 is a schematic diagram of an integrated propulsion and power generation system for a spacecraft according to the present disclosure. The integrated propulsion and power generation system for a spacecraft includes a propellent supply module, an engine branch, and a power generation branch.

The propellant supply module includes a first high-pressure gas cylinder 4, a fuel storage tank 2, a first high-pressure gas cylinder 5, an oxidant storage tank 3, a first liquid path self-locking valve 14, a second liquid path self-locking valve 24, a first reversing valve 15, and a second reversing valve 25. The first high-pressure gas cylinder 4 is connected to the fuel storage tank 2 through a pipeline III, and the second high-pressure gas cylinder 5 is connected to the oxidant storage tank 3 through a pipeline IV.

The pipeline III is sequentially provided with a first filter 11, a first gas path self-locking valve 12, and a first pressure reducing valve 13. An input end of the first filter 11 is connected to the first high-pressure gas cylinder 4, and an output end of the first pressure reducing valve 13 is connected to an input end of the fuel storage tank 3.

The pipeline IV is sequentially provided with a second filter 21, a second gas path self-locking valve 22, and a second pressure reducing valve 23. An input end of the second filter 21 is connected to the second high-pressure gas cylinder 5, and an output end of the second pressure reducing valve 23 is connected to an input end of the oxidant storage tank 3.

An input end of the first liquid path self-locking valve 14 is connected to an output end of the fuel storage tank 2, and an output end of the first liquid path self-locking valve 14 is connected to a first input end of the first reversing valve 15. An input end of the second liquid path self-locking valve 24 is connected to an output end of the oxidant storage tank 3, and an output end of the second liquid path self-locking valve 24 is connected to an input end of the second reversing valve 25.

The engine branch includes a first one-way valve (not shown in the figure), a second one-way valve (not shown in the figure), and a main engine. A first output end of the first reversing valve 15 is connected to a first input end of the main engine, 1 and a first output end of the second reversing valve 25 is connected to a second input end of the main engine 1.

The power generation branch includes a first flow control valve 31, a second flow control valve 32, a gas generator 33, a turbine 34, a power generator 35, and a battery pack 36. A second output end of the first reversing valve 15 is connected to the first flow control valve 31, and a second transmission end of the second reversing valve 25 is connected to an input end of the second flow control valve 32. An output end of the first flow control valve 31 and an output end of the second flow control valve 32 are separately connected to the gas generator 33, and an output end of the gas generator 33 is connected to a gas inlet end of the turbine 34. The fuel and the oxidant are combusted inside the gas generator 33 to generate high-temperature and high-pressure gas. The turbine 34 is pushed by the gas to rotate to drive the power generator 35 to work. Electric energy is stored in the battery pack 36 to supply power to a related load device in the integrated propulsion and power generation system for a spacecraft.

The first reversing valve 15 and the second reversing valve 25 are three-position four-way valves. The engine branch and the power generation branch are disposed in parallel. The integrated propulsion and power generation system for a spacecraft is further provided with a controller that is configured to: control the first reversing valve 15 and the second reversing valve 25 to switch states, and control a propellent to flow into the engine branch or the power generation branch, achieving a propulsion function or a power generation function.

The first reversing valve 15 and the second reversing valve 25 each have three working modes.

In a working mode I, the first reversing valve 15 and the second reversing valve 25 are in an initial state, a first output end of the first reversing valve 15 and a first output end of the second reversing valve 25 are connected to the engine branch, and a second output end of the first reversing valve 15 and a second output end of the second reversing valve 25 are connected to the power generation branch; and the fuel and the oxidant flow to the engine branch and the power generation branch after passing through the first reversing valve 15 and the second reversing valve 25.

In a working mode II, a first interface of the first reversing valve 15 is connected to a fourth interface of the second reversing valve 25, and a second interface of the first reversing valve 15 is disconnected from a third interface of the second reversing valve 25. The fuel and the oxidant flow to the engine branch after passing through the first reversing valve 15 and the second reversing valve 25.

In a working mode III, a first interface of the first reversing valve 15 is connected to a third interface of the second reversing valve 25, and a second interface of the first reversing valve 15 is disconnected form a fourth interface of the second reversing valve 25. The fuel and the oxidant flow to the power generation branch after passing through the first reversing valve 15 and the second reversing valve 25.

According to the present disclosure, a propulsion function and a power generation function are integrated through the engine branch and the power generation branch that are connected in parallel. The first reversing valve 15 and the second reversing valve 25 are switched in a plurality of modes to convert chemical energy of excessive fuel carried in the spacecraft into electric energy, improving fuel utilization.

Further, the integrated propulsion and power generation system for a spacecraft provided in the present disclosure is further provided with a tail gas treatment unit that is configured to acquire and process the high-temperature and high-pressure gas generated in the gas generator 33 after the high-temperature and high-pressure gas is cooled and depressurized via the turbine 34, making exhausted tail gas not cause additional disturbing force on the spacecraft. The tail gas treatment unit provided in the present disclosure is further described with reference to FIG. 3 and FIG. 4. The tail gas treatment unit includes a throttling component and tail gas treatment device. The throttling component includes a first throttling element 41 and a second throttling element 42 that are configured to throttle gas output by the turbine 34.

The tail gas treatment device 43 is connected in parallel between two ends of the first throttling element 41 and the second throttling element 42, and includes an exhaust pipe 431. A plurality of exhaust vents 4311 are provided on each of a first end and a second end of the exhaust pipe 431. A quantity of exhaust vents 4311 may be 4, 5, 8, 10, or the like, and may be set by a person skilled in the art according to an actual requirement. Preferably, there are 8 exhaust vents 4311 that are uniformly disposed on outer edges of the first end and the second end of the exhaust pipe 431.

The tail gas treatment device 43 further includes a first inlet pipe 432 and a second inlet pipe 433 that are disposed on the middle of the exhaust pipe 431 and are connected to the first throttling element 41 and the second throttling element 42. An output end of the first throttling element 41 is connected to an inlet end of the first inlet pipe 432, and an output end of the second throttling element 42 is connected to an inlet end of the second inlet pipe 433. Gas flowing through the throttling component enters the exhaust pipe 431 through the first inlet pipe 432 and the second inlet pipe 433, and kinetic energy is further consumed through mutual impact.

To further optimize a mutual impact effect, a third throttling element 4312 and a fourth throttling element 4313 are further symmetrically distributed on a joint between the first inlet pipe 432 and the exhaust pipe 431 and a joint between the second inlet pipe 433 and the exhaust pipe 431. The third throttling element 4312 and the fourth throttling element 4313 are preferably orifices with consistent dimensions.

Gas output by the turbine 34 enters the first inlet pipe 432 and the second inlet pipe 433 through the first throttling element 41 and the second throttling element 42, and flows through the third throttling element 4312 and the fourth throttling element 4313 to enter the exhaust pipe 431. A part of kinetic energy is consumed through mutual impact. Counterforce of gas flowing through the exhaust vents 4311 of the exhaust pipe 431 on the structure is cancelled out, to eliminate disturbing force on the spacecraft in a tail gas exhaust process.

The present disclosure further provides a control method of an integrated propulsion and power generation system for a spacecraft. The integrated propulsion and power generation system is further provided with a plurality of flow detection apparatuses that are configured to detect flow of the fuel and oxidant flowing into the main engine.

When the first reversing valve 15 and the second reversing valve 25 are in the working mode I, the propellant supply module is configured to provide the fuel and the oxidant to the engine branch and the power generation branch. The controller is configured to control an opening degree of the first flow control valve 31 and an opening degree of the second flow control valve 32, to control fuel flow and oxidant flow of the engine branch.

The control method includes the follow steps.

A real-time opening degree value of the first flow control valve 31 and a real-time opening degree value of the second flow control valve 32 are calculated according to a preset condition.

An opening degree of the first flow control valve 31 is controlled by the controller according to the real-time opening degree value of the first flow control valve 31, and an opening degree of the second flow control valve 32 is controlled by the controller according to the real-time opening degree value of the second flow control valve 32.

A fuel supply flow path is used as an example. Outlet flow of the fuel storage tank 2 meets the following formula:

$${Q}_{storage tank} = {Q}_{t} + {Q}_{1} , \qquad ( 1 )$$

where
Q_{storage tank} is the outlet flow of the fuel storage tank 2, Qₜ is fuel flow of the engine branch, and Q₁ is fuel flow of the power generation branch.

The first flow control valve 31 has an equal percentage logarithmic flow control characteristic, and a calculation formula is as follows:

$$ln \frac{{Q}_{1}}{{Q}_{max}} = k \frac{1}{L} + C , \qquad ( 2 )$$

where

Boundary conditions are follows:
when Q=Qₘᵢₙ, l=0;
when Q =Qₘₐₓ, l=L;

$$R = \frac{{Q}_{min}}{{Q}_{max}}$$

the boundary conditions are substituted into the formula (2) to deduce the following formula:

$$\frac{{Q}_{1}}{{Q}_{max}} = \frac{{e}^{( \frac{1}{L} lnR )}}{R} , \qquad ( 3 )$$

where
Qₗ is the fuel flow, Qₘᵢₙ and Qₘₐₓ are minimum flow and maximum flow of the flow control valve, R is a ratio of the minimum flow to the maximum flow, l is an opening degree of the first flow control valve 31, and L is a maximum opening degree of the first flow control valve 31; and for a selected flow control valve, Qₘᵢₙ, Qₘₐₓ, and L are known values.

Target fuel flow of the engine branch is set as Qₛ, actual flow of the engine branch is set as Qₜ, and a formula for calculating a real-time opening degree of the first flow control valve 31 is as follows:

$${l}_{t + 1} = {l}_{t} + Δ l \qquad ( 4 )$$

$$Δ l = - \frac{{Q}_{t} - {Q}_{s}}{λ} - \frac{( {Q}_{t} + {Q}_{t - Δ t} + {Q}_{t - 2 Δ t} - {Q}_{t - 3 Δ t} - {Q}_{t - 4 Δ t} - {Q}_{t - 5 Δ t} )}{5 Δ t} * μ * κ ,$$

where
lₜ₊₁ is an opening degree of the first flow control valve 31 at a next moment, lₜ is an opening degree of the first flow control valve at a current moment, Δl is an opening degree control increment, Qₜ is flow of the engine branch at the current moment, Qₛ is the target flow of the engine branch, λ is a proportion coefficient, Δt is a sampling interval of the system, Qₜ to Q_{t-5Δt} respectively correspond to flow, that is sampled for six consecutive times, of the engine branch, and μ is a compensation coefficient; and Qₜ−Qₛ represents a difference between the flow at the current moment and the target flow, and

$$\frac{( {Q}_{t} + {Q}_{t - Δ t} + {Q}_{t - 2 Δ t} - {Q}_{t - 3 Δ t} - {Q}_{t - 4 Δ t} - {Q}_{t - 5 Δ t} )}{5 Δ t}$$

represents a change value of Qₜ.

κ is a correction coefficient, where when t>6Δt, κ=1; and when t≤6Δt, κ=0.

In the formula, sampling time, and a sampling moment obtained through averaging are set according to an actual requirement. For example, flow of the engine branch at previous four, six or eight sampling intervals is acquired, and an average value is obtained as the flow of the engine branch.

The controller is configured to control the opening degree of the first flow control valve 31 according to the obtained real-time opening value of the first flow control valve 31.

For a fuel supply flow path, a corresponding method for calculating the opening degree of the second flow control valve 32 is same as that of the first flow control valve 31. Details are not described again herein.

According to the present disclosure, the propulsion function and the power generation function are integrated through the engine branch and the power generation branch that are connected in parallel. The first reversing valve and the second reversing valve are switched in a plurality of modes to convert chemical energy of excessive fuel carried in the spacecraft into electric energy. In addition, a working requirement of the propulsion system and a requirement for the power generation function of the aircraft are met, and requirements in different use scenarios are met. In addition, flow distribution is adjusted by the control method to adjust thrust and generated power of the propulsion and power generation system, achieving integrated control on the propulsion function and the power generation function of the spacecraft.

In addition, when the fuel flow is lower than a preset value, the propellent can be replenished to the integrated propulsion and power generation system provided in the present disclosure based on an in-orbit propellent replenishment technology. Therefore, long-term in-orbit service of the integrated propulsion and power generation system can be achieved.

It should be understood that in the description of the present disclosure, terms such as “upper”, “lower”, “front”, “rear”, “left”, “right” “vertical”, “horizontal”, “top”, “bottom”, “inside” and “outside” indicate the orientations or positional relationships based on the drawings, and these terms are merely intended to facilitate and simplify the description of the present disclosure, rather than to indicate or imply that the mentioned apparatus or element must have a specific orientation or must be constructed and operated in a specific orientation, and thus cannot be construed as limitations to the present disclosure.

The specific embodiments of the present disclosure are described above. It should be understood that the present disclosure is not limited to the above specific implementations, and a person skilled in the art can make various variations or modifications within the scope of the claims without affecting the essence of the present disclosure. The embodiments of the present disclosure and features in the embodiments may be arbitrarily combined with each other in a non-conflicting situation.

1. An integrated propulsion and power generation system for a spacecraft, comprising a propellant supply module, an engine branch, a power generation branch, and a controller, wherein
the propellant supply module comprises a first reversing valve and a second reversing valve; and
the controller is configured to: control the first reversing valve and the second reversing valve to switch states, and control the propellant supply module to be connected to one or two of the engine branch and the power generation branch.

2. The integrated propulsion and power generation system for a spacecraft according to claim 1, wherein the propellant supply module further comprises a first high-pressure gas cylinder, a fuel storage tank, a second high-pressure gas cylinder, an oxidant storage tank, a first liquid path self-locking valve, and a second liquid path self-locking valve, wherein
an input end of the first liquid path self-locking valve is connected to an output end of the fuel storage tank, and an output end of the first liquid path self-locking valve is connected to a first input end of the first reversing valve; and
an input end of the second liquid path self-locking valve is connected to an output end of the oxidant storage tank, and an output end of the second liquid path self-locking valve is connected to an input end of the second reversing valve.

3. The integrated propulsion and power generation system for a spacecraft according to claim 2, wherein outlet flow of the fuel storage tank meets the following formula:
$${Q}_{storage tank} = {Q}_{t} + {Q}_{1} , \qquad ( 1 )$$
wherein
Q_{storage tank} is the outlet flow of the fuel storage tank, Qₜ is fuel flow of the engine branch, and Qₗ is fuel flow of the power generation branch.

4. The integrated propulsion and power generation system for a spacecraft according to claim 1, wherein the engine branch comprises a main engine, a first output end of the first reversing valve is connected to a first input end of the main engine, and a first output end of the second reversing valve is connected to a second input end of the main engine.

5. The integrated propulsion and power generation system for a spacecraft according to claim 1, wherein the power generation branch comprises a first flow control valve, a second flow control valve, a gas generator, a turbine, a power generator, and a battery pack, wherein
a second output end of the first reversing valve is connected to the first flow control valve, a second transmission end of the second reversing valve is connected to an input end of the second flow control valve; and an output end of the first flow control valve and an output end of the second flow control valve are separately connected to the gas generator, and an output end of the gas generator is connected to a gas inlet end of the turbine.

6. (canceled)

7. The integrated propulsion and power generation system for a spacecraft according to claim 1, wherein the first reversing valve and the second reversing valve are three-position four-way valves; and the controller is configured to control the first reversing valve and the second reversing valve to switch among a working mode I, a working mode II, and a working mode III.

8. The integrated propulsion and power generation system for a spacecraft according to claim 1, wherein the system further comprises a tail gas treatment unit, and the tail gas treatment unit comprises a throttling component and a tail gas treatment device.

9. The integrated propulsion and power generation system for a spacecraft according to claim 8, wherein the throttling component comprises a first throttling element and a second throttling element, and is configured to throttle gas output by the turbine.

10. The integrated propulsion and power generation system for a spacecraft according to claim 9, wherein the tail gas treatment device comprises an exhaust pipe, and each of a first end and a second end of the exhaust pipe is provided with a plurality of exhaust vents.

11. The integrated propulsion and power generation system for a spacecraft according to claim 10, wherein a middle part of the exhaust pipe is further provided with a first inlet pipe, and a second inlet pipe; an output end of the first throttling element is connected to an inlet end of the first inlet pipe, and an output end of the second throttling element is connected to an inlet end of the second inlet pipe; and
a joint between the first inlet pipe and the exhaust pipe and a joint between the second inlet pipe and the exhaust pipe are further provided with a third throttling element and a fourth throttling element.

12. A control method of an integrated propulsion and power generation system for a spacecraft, wherein the method is applied to the integrated propulsion and power generation system for a spacecraft according to claim 1, wherein the method comprises the following steps:
calculating a real-time opening degree value of a first flow control valve and a real-time opening degree value of a second flow control valve according to a preset condition; and
controlling, by a controller, an opening degree of the first flow control valve according to the real-time opening degree value of the first flow control valve, and an opening degree of the second flow control valve according to the real-time opening degree value of the second flow control valve.

13. The control method of an integrated propulsion and power generation system for a spacecraft according to claim 12, wherein the propellant supply module further comprises a first high-pressure gas cylinder, a fuel storage tank, a second high-pressure gas cylinder, an oxidant storage tank, a first liquid path self-locking valve, and a second liquid path self-locking valve, wherein
an input end of the first liquid path self-locking valve is connected to an output end of the fuel storage tank, and an output end of the first liquid path self-locking valve is connected to a first input end of the first reversing valve; and
an input end of the second liquid path self-locking valve is connected to an output end of the oxidant storage tank, and an output end of the second liquid path self-locking valve is connected to an input end of the second reversing valve.

14. The control method of an integrated propulsion and power generation system for a spacecraft according to claim 13, wherein outlet flow of the fuel storage tank meets the following formula:
$${Q}_{storage tank} = {Q}_{t} + {Q}_{1} , \qquad ( 1 )$$
wherein
Q_{storage tank} is the outlet flow of the fuel storage tank, Qₜ is fuel flow of the engine branch, and Qₗ is fuel flow of the power generation branch.

15. The control method of an integrated propulsion and power generation system for a spacecraft according to claim 12, wherein the engine branch comprises a main engine, a first output end of the first reversing valve is connected to a first input end of the main engine, and a first output end of the second reversing valve is connected to a second input end of the main engine.

16. The control method of an integrated propulsion and power generation system for a spacecraft according to claim 12, wherein the power generation branch comprises a first flow control valve, a second flow control valve, a gas generator, a turbine, a power generator, and a battery pack, wherein
a second output end of the first reversing valve is connected to the first flow control valve, a second transmission end of the second reversing valve is connected to an input end of the second flow control valve; and an output end of the first flow control valve and an output end of the second flow control valve are separately connected to the gas generator, and an output end of the gas generator is connected to a gas inlet end of the turbine.

17. The control method of an integrated propulsion and power generation system for a spacecraft according to claim 12, wherein the first reversing valve and the second reversing valve are three-position four-way valves; and the controller is configured to control the first reversing valve and the second reversing valve to switch among a working mode I, a working mode II, and a working mode III.

18. The control method of an integrated propulsion and power generation system for a spacecraft according to claim 12, wherein the system further comprises a tail gas treatment unit, and the tail gas treatment unit comprises a throttling component and a tail gas treatment device.

19. The control method of an integrated propulsion and power generation system for a spacecraft according to claim 18, wherein the throttling component comprises a first throttling element and a second throttling element, and is configured to throttle gas output by the turbine.

20. The control method of an integrated propulsion and power generation system for a spacecraft according to claim 19, wherein the tail gas treatment device comprises an exhaust pipe, and each of a first end and a second end of the exhaust pipe is provided with a plurality of exhaust vents.

21. The control method of an integrated propulsion and power generation system for a spacecraft according to claim 20, wherein a middle part of the exhaust pipe is further provided with a first inlet pipe, and a second inlet pipe; an output end of the first throttling element is connected to an inlet end of the first inlet pipe, and an output end of the second throttling element is connected to an inlet end of the second inlet pipe; and
a joint between the first inlet pipe and the exhaust pipe and a joint between the second inlet pipe and the exhaust pipe are further provided with a third throttling element and a fourth throttling element.
